(19) United States
(12) Patent Application Publication
(10) Pub. No.: US 2013/0159630 A1
(43) Pub. Date: Jun. 20, 2013

(54) SELECTIVE CACHE FOR INTER-OPERATIONS IN A PROCESSOR-BASED ENVIRONMENT

(71) Applicant: Yury Lichmanov, Richmond Hill (CA)

(72) Inventor: Yury Lichmanov, Richmond Hill (CA)

(73) Assignee: ATI Technologies ULC

(21) Appl. No.: 13/332,260

(22) Filed: Dec. 20, 2011

(51) Int. Cl. G06F 12/12

(52) U.S. Cl. 711/133; 711/E12.07

(57) ABSTRACT

The present invention provides embodiments of methods and apparatuses for selective caching of data for inter-operations in a heterogeneous computing environment. One embodiment of a method includes allocating a portion of a first cache for caching for two or more processing elements and defining a replacement policy for the allocated portion of the first cache. The replacement policy restricts access to the first cache to operations associated with more than one of the processing elements.

### BACKGROUND

This subject matter described herein relates generally to processor-based systems, and, more particularly, to selected caching of data in processor-based systems.

Many processing devices utilize caches to reduce the average time required to access information stored in a memory. A cache is a smaller and faster memory that stores copies of instructions and/or data that are expected to be used relatively frequently. For example, central processing units (CPUs) are generally associated with a cache or a hierarchy of cache memory elements. Processors other than CPUs, such as, for example, graphics processing units (GPUs), accelerated processing units (APUs), and others, are also known to use caches. Instructions or data that are expected to be used by the CPU are moved from (relatively large and slow) main memory into the cache. When the CPU needs to read or write a location in the main memory, it first checks to see whether the desired memory location is included in the cache memory. If this location is included in the cache (a cache hit), then the CPU can perform the read or write operation on the copy in the cache memory location. If this location is not included in the cache (a cache miss), then the CPU needs to access the information stored in the main memory and, in some cases, the information can be copied from the main memory and added to the cache. Proper configuration and operation of the cache can reduce the latency of memory accesses below the latency of the main memory to a value close to the value of the cache memory.

One widely used architecture for a CPU cache memory is a hierarchical cache that divides the cache into two levels known as the L1 cache and the L2 cache. The L1 cache is typically a smaller and faster memory than the L2 cache, which is smaller and faster than the main memory. The CPU first attempts to locate needed memory locations in the L1 cache and then proceeds to look successively in the L2 cache and the main memory when it is unable to find the memory location in the cache. The L1 cache can be further subdivided into separate L1 caches for storing instructions (L1-I) and data (L1-D). The L1-I cache can be placed near entities that require more frequent access to instructions than data, whereas the L1-D can be placed closer to entities that require more frequent access to data than instructions. The L2 cache is typically associated with both the L1-I and L1-D caches and can store copies of instructions or data that are retrieved from the main memory. Frequently used instructions are copied from the L2 cache into the L1-I cache and frequently used data can be copied from the L2 cache into the L1-D cache. The L2 cache is therefore referred to as a unified cache.

Caches are typically flushed prior to powering down the CPU. Flushing includes writing back modified or “dirty” cache lines to the main memory and invalidating all of the lines in the cache. Microcode can be used to sequentially flush different cache elements in the CPU cache. For example, in conventional processors that include an integrated L2 cache, microcode first flushes the L1 cache by writing dirty cache lines into main memory. Once flushing of the L1 cache is complete, the microcode flushes the L2 cache by writing dirty cache lines into the main memory.

### SUMMARY OF EMBODIMENTS

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for selective caching of data for inter-operations in a heterogeneous computing environment. One embodiment of a method includes allocating a portion of a first cache for caching for two or more processing elements and defining a replacement policy for the allocated portion of the first cache. The replacement policy restricts access to the first cache to operations associated with more than one of the processing elements. The processing elements may include a central processing unit, graphics processing unit, accelerated processing unit, and/or processor cores. One embodiment of an apparatus includes means for allocating a portion of the first cache and means for defining the replacement policy for the allocated portion of the first cache.

In another embodiment, a method is provided for selective caching of data for inter-operations in a processor-based computing environment. One embodiment of the method includes caching data in a cache memory that is communicatively coupled to two or more processing elements according to a replacement policy that restricts access to the cache memory to data for operations associated with more than one of the processing elements. The processing elements may include a central processing unit, graphics processing unit, accelerated processing unit, and/or processor cores. One embodiment of an apparatus includes means for caching the data in the cache memory.

In yet another embodiment, an apparatus is provided for selective caching of data for inter-operations in a processor-based computing environment. The apparatus includes two or more processing units and a first cache that is communicatively coupled to the processing elements. The first cache is adaptable to cache data according to a replacement policy that restricts access to the first cache to operations associated with more than one of the processing elements. The processing elements may include a central processing unit, graphics processing unit, accelerated processing unit, and/or processor cores.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a computer system;

FIG. 2 conceptually illustrates a second exemplary embodiment of a computer system;

FIG. 3 conceptually illustrates a third exemplary embodiment of a computer system; and

FIG. 4 conceptually illustrates one exemplary embodiment of a method of selectively caching inter-operation data.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present application describes embodiments of techniques for caching data and/or instructions in a common cache that can be accessed by multiple processing units such as central processing units (CPUs), graphics processing units (GPUs), accelerated processing units (APUs), and the like. Computer systems such as systems-on-a-chip that include multiple processing units or cores implemented on a single substrate may also include a common cache that can be accessed by the processing units or cores. For example, a CPU and a GPU can share a common L3 cache when the processing units are implemented on the same chip. Caches such as the common L3 cache are fundamentally different than standard memory elements because they operate according to a cache replacement policy or algorithm, which is a set of instructions and/or rules that are used to determine how to add data to the cache and remove (or evict) data from the cache.

The cache replacement policy may have a significant effect upon the performance of computing applications that use multiple processing elements to implement an application. For example, cache replacement policy may have a significant effect upon heterogeneous applications that involve the CPU, GPU, APU, and/or any other processing units. For another example, the cache replacement policy may affect the performance of applications that utilize or share multiple processor cores in a homogeneous multicore environment. The residency time for data stored in a cache may depend on parameters such as the size of the cache, the cache hit/miss rate, the replacement policy for the cache, and the like. Using the common cache for generic processor operations may decrease the residency time for data in the cache, e.g., because the overall number of cache hits/misses may be increased relative to situations in which a restricted set of data is allowed to use the common cache and data that is not part of the restricted set is required to bypass the common cache and be sent directly to main memory. Generic CPU operations are expected to consume a significant part of the memory dedicated for a common L3 cache, which may reduce the residency time for data stored in the L3 cache. Reducing the overall residency time for data in the cache reduces the residency time for data used by inter-operations, e.g., operations that involve both the CPU and the GPU such as pattern recognition techniques, video processing techniques, gaming, and the like. Consequently, using a common L3 cache for generic CPU operations is not expected to boost performance for standard CPU applications/benchmarks.

In contrast, caching inter-operation data in the common L3 cache can significantly improve performance of applications that utilize multiple processing elements such as heterogeneous computing applications (e.g., applications that employ or involve operations by two or more different types of processor units or cores) that involve the CPU, GPU, and/or any other processing units. As used herein, the term “inter-operation data” will be understood to refer to data and/or instructions that may be accessed and/or utilized by more than one processing unit for performing one or more applications. However, if cache replacement policy allows both the inter-operation data and generic processor data (e.g., data and/or instructions that are only accessed by a single processing unit when performing application) to be read and/or written to the common cache, the reduction of the residency time for inter-operation data caused by caching data for generic CPU operations in a common L3 cache can degrade the performance of applications that involve a significant percentage of inter-operations and in some cases degrade the overall performance of the system. A similar problem may occur on the GPU side because using the L3 cache for generic GPU texture operations (which do not typically involve the CPU) may steal memory bandwidth from more sensitive clients such as depth buffers and/or color buffers.

Embodiments of the techniques described herein may be used to improve or enhance the performance of applications such as heterogeneous computing applications using a cache replacement policy that only allows data associated with a subset of operations to be written back to a common cache memory. In one embodiment, portions of a common cache memory that is shared by multiple processing elements can be allocated to inter-operation data that may be accessed and/or utilized by at least two of the multiple processing elements when performing one or more operations or applications. For example, inter-operation data can be flagged to indicate that the inter-operation data should use the common cache. Data that is not flagged bypasses the common cache, e.g., data that is evicted from the local caches in the processing units is written back to the main memory and not to the common cache if it has not been flagged. Inter-operation data that has been flagged can be written to the common cache when it has been evicted from a cache and/or a write combine buffer in one of the other processing units. Exemplary cache replacement policy modes may include “InterOp Cached” for data that is placed into the common cache following eviction from a CPU/GPU cache. This data remains in the common cache until it is evicted and/or aged according to the caching policy. The common cache can also be used to receive data from a write/combine buffer when the state is flushed from the write/combine buffer and remains in the common cache until evicted/aged.

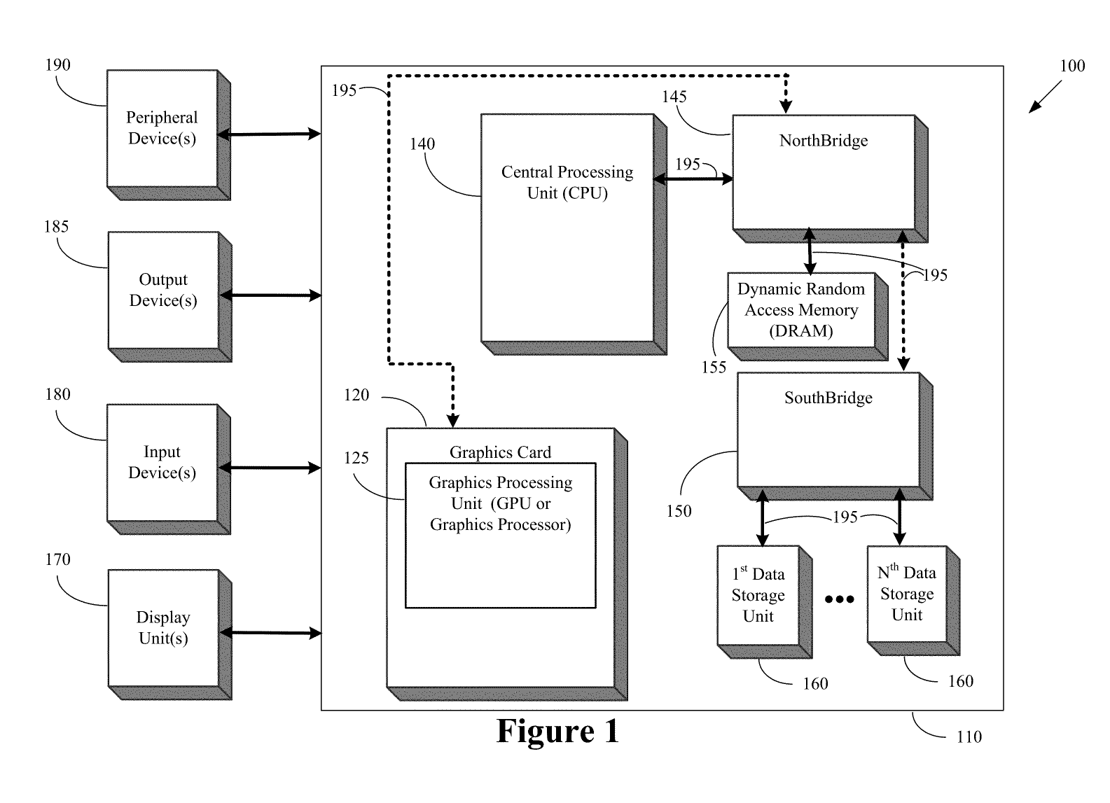

FIG. 1 conceptually illustrates a first exemplary embodiment of a computer system 100. In various embodiments, the computer system 100 may be a personal computer, a laptop computer, a handheld computer, a netbook computer, a mobile device, a telephone, a personal data assistant (PDA), a server, a mainframe, a work terminal, a tablet, or the like. The computer system includes a main structure 110 which may be a computer motherboard, system-on-a-chip, circuit board or printed circuit board, a desktop computer enclosure and/or tower, a laptop computer base, a server enclosure, part of a mobile device, personal data assistant (PDA), or the like. In one embodiment, the computer system 100 runs an operating system such as Linux, Unix, Windows, Mac OS, OS X, Android, iOS, or the like.

In the illustrated embodiment, the main structure 110 includes a graphics card 120. For example, the graphics card 120 may be an ATI Radeon™ graphics card from Advanced Micro Devices (“AMD”). The graphics card 120 may, in different embodiments, be connected on a Peripheral Component Interconnect (PCI) Bus (not shown), PCI-Express Bus (not shown), an Accelerated Graphics Port (AGP) Bus (also not shown), or other electronic and/or communicative connection. In one embodiment, the graphics card 120 may contain a graphics processing unit (GPU) 125 used in processing graphics data. In various embodiments the graphics card 120 may be referred to as a circuit board or a printed circuit board or a daughter card or the like. In one embodiment, the GPU 125 may implement one or more shaders. Shaders are programs or algorithms that can be used to define and/or describe the traits, characteristics, and/or properties of either a vertex or a pixel. For example, vertex shaders may be used to define or describe the traits (position, texture coordinates, colors, etc.) of a vertex, while pixel shaders may be used to define or describe the traits (color, z-depth and alpha value) of a pixel. An instance of a vertex shader may be called or executed for each vertex in a primitive, possibly after tessellation in some embodiments. Each vertex may be rendered as a series of pixels onto a surface, which is a block of memory allocated to store information indicating the traits or characteristics of the pixels and/or the vertex. The information in the surface may eventually be sent to the screen so that an image represented by the vertex and/or pixels may be rendered.

The computer system 100 shown in FIG. 1 also includes a central processing unit (CPU) 140, which is electronically and/or communicatively coupled to a northbridge 145. The CPU 140 and northbridge 145 may be housed on the motherboard (not shown) or some other structure of the computer system 100. It is contemplated that in certain embodiments, the graphics card 120 may be coupled to the CPU 140 via the northbridge 145 or some other electronic and/or communicative connection. For example, CPU 140, northbridge 145, GPU 125 may be included in a single package or as part of a single die or “chip”. In certain embodiments, the northbridge 145 may be coupled to a system RAM (or DRAM) 155 and in other embodiments the system RAM 155 may be coupled directly to the CPU 140. The system RAM 155 may be of any RAM type known in the art; the type of RAM 155 does not limit the embodiments of the present invention. In one embodiment, the northbridge 145 may be connected to a southbridge 150. In other embodiments, the northbridge 145 and southbridge 150 may be on the same chip in the computer system 100, or the northbridge 145 and southbridge 150 may be on different chips. In various embodiments, the southbridge 150 may be connected to one or more data storage units 160. The data storage units 160 may be hard drives, solid state drives, magnetic tape, or any other writable media used for storing data. In various embodiments, the central processing unit 140, northbridge 145, southbridge 150, graphics processing unit 125, and/or DRAM 155 may be a computer chip or a silicon-based computer chip, or may be part of a computer chip or a silicon-based computer chip. In one or more embodiments, the various components of the computer system 100 may be operatively, electrically and/or physically connected or linked with a bus 195 or more than one bus 195 or other interfaces.

The computer system 100 may be connected to one or more display units 170, input devices 180, output devices 185, and/or peripheral devices 190. In various alternative embodiments, these elements may be internal or external to the computer system 100 and may be wired or wirelessly connected. The display units 170 may be internal or external monitors, television screens, handheld device displays, and the like. The input devices 180 may be any one of a keyboard, mouse, track-ball, stylus, mouse pad, mouse button, joystick, scanner or the like. The output devices 185 may be any one of a monitor, printer, plotter, copier, or other output device. The peripheral devices 190 may be any other device that can be coupled to a computer. Exemplary peripheral devices 190 may include a CD/DVD drive capable of reading and/or writing to physical digital media, a USB device, Zip Drive, external floppy drive, external hard drive, phone and/or broadband modem, router/gateway, access point and/or the like.

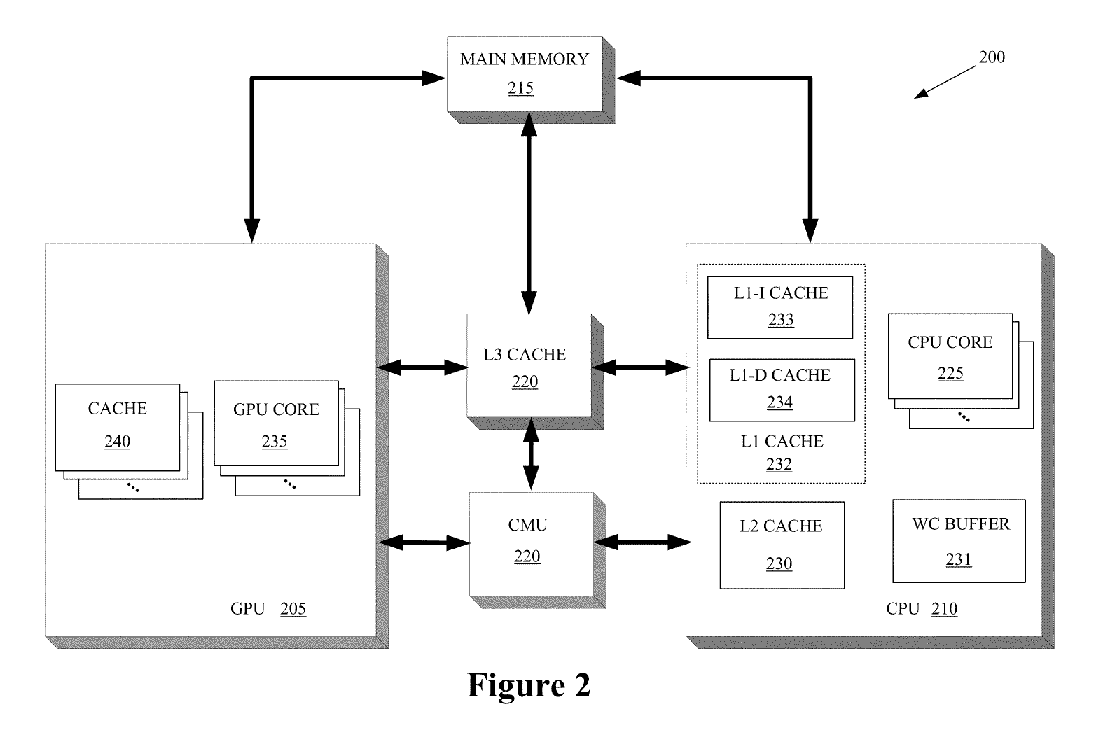

FIG. 2 conceptually illustrates a second exemplary embodiment of a semiconductor device 200 that may be formed in or on a semiconductor wafer (or die). The semiconductor device 200 may formed in or on the semiconductor wafer using well known processes such as deposition, growth, photolithography, etching, planarising, polishing, annealing, and the like. The second exemplary embodiment of the semiconductor device includes multiple processors such as a graphics processing unit (GPU) 205 and a central processing unit (CPU) 210. Additional processors such as an accelerated processing unit (APU) may also be included in other embodiments of the semiconductor device 200. The exemplary embodiment of the semiconductor device 200 also includes a main memory 215 and a common (L3) cache 220 that is communicatively coupled to the processing units 205, 210. In one embodiment, the second exemplary embodiment of the semiconductor device 200 may be implemented or formed as part of the first exemplary embodiment of the computer system 100. For example, the GPU 205 may correspond to the GPU 125, the CPU 210 may correspond to the CPU 140, and the main memory 215 and the common cache 220 may be implemented as part of the memory elements 160, 195. However, alternative embodiments of the semiconductor device 200 may be implemented in systems that differ from the exemplary embodiment of the computer system 100 shown in FIG. 1.

In some embodiments, other elements may intervene between the elements shown in FIG. 2 without necessarily preventing these entities from being electronically and/or communicatively coupled as indicated. Moreover, in the interest of clarity, FIG. 2 does not show all of the electronic interconnections and/or communication pathways between the elements in the device 200. Persons of ordinary skill in the art having benefit of the present disclosure should appreciate that the elements in the device 200 may communicate and/or exchange electronic signals along numerous other pathways that are not shown in FIG. 2. For example, information may be exchanged over buses, bridges, or other interconnections.

In the illustrated embodiment, the central processing unit (CPU) 210 is configured to access instructions and/or data that are stored in the main memory 215. In the illustrated embodiment, the CPU 210 includes one or more CPU cores 225 that are used to execute the instructions and/or manipulate the data. The CPU 210 also implements a hierarchical (or multilevel) cache system that is used to speed access to the instructions and/or data by storing selected instructions and/or data in the caches. However, persons of ordinary skill in the art having benefit of the present disclosure should appreciate that alternative embodiments of the device 200 may implement different configurations of the CPU 210, such as configurations that use external caches or different types of processors (e.g., APUs).

The illustrated cache system includes a level 2 (L2) cache 230 for storing copies of instructions and/or data that are stored in the main memory 215. In the illustrated embodiment, the L2 cache 230 is 4-way associative to the main memory 215 so that each line in the main memory 215 can potentially be copied to and from 4 particular lines (which are conventionally referred to as “ways”) in the L2 cache 230. However, persons of ordinary skill in the art having benefit of the present disclosure should appreciate that alternative embodiments of the main memory 215 and/or the L2 cache 230 can be implemented using any associativity including 2-way associativity, 16-way associativity, direct mapping, fully associative caches, and the like. Relative to the main memory 215, the L2 cache 230 may be implemented using smaller and faster memory elements. The L2 cache 230 may also be deployed logically and/or physically closer to the CPU core(s) 225 (relative to the main memory 215) so that information may be exchanged between the CPU core(s) 225 and the L2 cache 230 more rapidly and/or with less latency.

The illustrated cache system also includes an L1 cache 232 for storing copies of instructions and/or data that are stored in the main memory 215 and/or the L2 cache 230. Relative to the L2 cache 230, the L1 cache 232 may be implemented using smaller and faster memory elements so that information stored in the lines of the L1 cache 232 can be retrieved quickly by the CPU 210. The L1 cache 232 may also be deployed logically and/or physically closer to the CPU core(s) 225 (relative to the main memory 215 and the L2 cache 230) so that information may be exchanged between the CPU core(s) 225 and the L1 cache 232 more rapidly and/or with less latency (relative to communication with the main memory 215 and the L2 cache 230). Persons of ordinary skill in the art having benefit of the present disclosure should appreciate that the L1 cache 232 and the L2 cache 230 represent one exemplary embodiment of a multi-level hierarchical cache memory system. Alternative embodiments may use different multilevel caches including elements such as L0 caches, L1 caches, L2 caches, and the like.

In the illustrated embodiment, the L1 cache 232 is separated into level 1 (L1) caches for storing instructions and data, which are referred to as the L1-I cache 233 and the L1-D cache 234. Separating or partitioning the L1 cache 232 into an L1-I cache 233 for storing only instructions and an L1-D cache 234 for storing only data may allow these caches to be deployed closer to the entities that are likely to request instructions and/or data, respectively. Consequently, this arrangement may reduce contention, wire delays, and generally decrease latency associated with instructions and data. In one embodiment, a replacement policy dictates that the lines in the L1-I cache 233 are replaced with instructions from the L2 cache 230 and the lines in the L1-D cache 234 are replaced with data from the L2 cache 232. However, persons of ordinary skill in the art should appreciate that alternative embodiments of the L1 cache 232 may not be partitioned into separate instruction-only and data-only caches 233, 234.

A write/combine buffer 231 may also be included in some embodiments of the CPU 210. Write combining is a computer bus technique for allowing different pieces, sections, or blocks of data to be combined and stored in the write combine buffer 231. The data stored in the write combine buffer 231 may be released at a later time, e.g., in burst mode, instead of writing the individual pieces, sections, or blocks of data as single bits or small chunks.

In the illustrated embodiment, the graphics processing unit (GPU) 205 is configured to access instructions and/or data that are stored in the main memory 215. In the illustrated embodiment, the GPU 205 includes one or more GPU cores 235 that are used to execute the instructions and/or manipulate the data. The GPU 205 also implements a cache 240 that is used to speed access to the instructions and/or data by storing selected instructions and/or data in the caches 240. In one embodiment, the cache 240 may be a hierarchical (or multilevel) cache system that is analogous to the L1 cache 232 and L2 cache 230 implemented in a CPU 210. However, alternative embodiments of the cache 240 may be a plain cache that is not implemented as a hierarchical or multilevel system. In various embodiments, the cache 240 can be implemented using any associativity including 2-way associativity, 4-way associativity, 16-way associativity, direct mapping, fully associative caches, and the like. Relative to the main memory 215, the cache 240 may be implemented using smaller and faster memory elements. The cache 240 may also be deployed logically and/or physically closer to the GPU core(s) 235 (relative to the main memory 215) so that information may be exchanged between the GPU core(s) 235 and the cache 240 more rapidly and/or with less latency.

In operation, the system 200 moves and/or copies information between the main memory 215 and the various caches 220, 230, 232, 240 according to one or more replacement policies that are defined for the caches 220, 230, 232, 240. In one embodiment, cache replacement policies dictate that the CPU 210 first checks the relatively low latency L1 caches 232, 233, 234 when it needs to retrieve or access an instruction or data. If the request to the L1 caches 232, 233, 234 misses, then the request may be directed to the L2 cache 230, which can be formed of a relatively larger and slower memory element than the L1 caches 232, 233, 234. The main memory 215 is formed of memory elements that are larger and slower than the L2 cache 230 and so the main memory 215 may be the object of a request when it receives cache misses from both the L1 caches 232, 233, 234 and the L2 cache 230. Cache replacement policies may dictate that data may be evicted from the caches 230, 232, 233, 234 when data is copied into the caches 230 232, 233, 234 following a cache miss to make room for the new data. These policies may also indicate that data can be evicted due to aging when it has been in the cache longer than a predetermined threshold time or duration. Cache replacement policies may also dictate that the GPU 205 first checks the relatively low latency cache(s) 240 when it needs to retrieve or access an instruction or data and then checks the main memory 215 if the requested information is not available in the cache 240. Cache replacement policies may dictate that data may be evicted from the cache(s) 240 due to aging or when data is copied into the cache(s) 240 following a cache miss to make room for the new data.

The main memory 215 and/or the caches 230, 232, 240 and/or the write combine buffer 231 can exchange information with the common (L3) cache 220 according to replacement policies defined for the various cache or buffer entities. In the illustrated embodiment, the cache replacement policies restrict the caching of data in the common cache 220 to a subset of the data that may be stored in the caches 230, 232, 240 and/or the write combine buffer 231. For example, the cache replacement policies defined for the common cache 220 may restrict the caching of data in the common cache 220 to data associated with applications and/or operations that involve both the GPU 205 and the CPU 210. These operations may be referred to as “inter-operations.” Examples of inter-operation data include data stored in unswizzled data buffers for compute/Fusion System Architectures (FSA), output buffers from multimedia encoding and/or transcoding applications or functions, command buffers including user rings, vertex and/or index buffers, multimedia source buffers, and other data buffers intended to be written by the CPU 210 and operated on (or “consumed”) by the GPU 205. Inter-operation data may also include data associated with surfaces generated or modified by the GPU 205 for various graphics operations and/or applications. In various embodiments, the GPU 205 and/or the CPU 210 may allocate portions of the common cache 220 for inter-operation data caching and/or define replacement policies for the allocated portions. The allocation and/or definition may be performed dynamically or using predetermined rules by a cache management unit 245. In the illustrated embodiment, the cache management unit 245 is a separate functional entity that is physically, electronically, and/or communicatively coupled to the GPU 205, CPU 210, L3 cache 220, and/or other entities in the system 200. However, in alternative embodiments, the cache management unit 245 may form part of either the CPU 210 or the GPU 205 or may alternatively be distributed between the CPU 210 and GPU 205. Additionally or alternatively, the cache management unit 245 may be formed in hardware, firmware, software or combinations thereof.

The data cache restrictions may be indicated using flags associated with the data and/or operations. In one embodiment, a flag can be set to indicate that data generated by a particular operation, e.g., by the CPU 210, and cached in one or more of the caches 230, 232 can be moved to the common cache 220 when it is evicted from the CPU cache 230, 232. For example, this flag may be set for interoperation data written by the CPU 210 for consumption by the GPU 205. In various embodiments, the L3 steering flags that are used to “steer” data to the common cache 220 may be newly defined flags implemented in the system 200 or combinations of conventional flags that indicate the caching policy for the cache 220. Similar flags can be defined for the write combine buffer 231 and the caches 240 in the GPU 205. For example, a flag can be set for data in the write combine buffer 231 so that data is written to the common cache 220 when it is flushed from the buffer 231. For another example, a flag can be set for the data associated with surfaces generated by the GPU 205 so that data evicted from the caches 240 is written to the common cache 220. Drivers in the GPU 205 and/or the CPU 210 may be used to set the various flags. For example, user mode (UMD) drivers and/or FSA Libs may be responsible for setting flags for relevant surfaces used by the GPU 205. Data stored in the caches 230, 232, 240 and/or buffers 231 may bypass the common cache 220 and be evicted directly to the memory 215 when the corresponding flag is not set for the data. For example, tiled surfaces should bypass the common cache 220 and so flags may not be set for data associated with tiled surfaces.

Restricting the data that can be cached in the common cache 220 to selected subsets of data and/or operations can increase the residency time for the data that is cached in the common cache 220. For example, if interoperation data is selectively cached in the common cache 220 and other data that is only used by one of the processing units bypasses the common cache 220, the residency time for the interoperation data may be increased because this data is less likely to be evicted in response to events such as a cache miss during a request for other types of data that are only used by a single processing unit. Increasing the residency time in this manner may improve the performance of the overall system 200 at least in part because the increased residency time allows data to remain in the common cache 220 so that it is accessible to multiple processing units such as CPUs, GPUs, and APUs for a longer period of time.

In one embodiment, the caches can be flushed by writing back modified (or “dirty”) cache lines to the main memory 215 and invalidating other lines in the caches. Cache flushing may be required for some instructions performed by the GPU 205, the CPU 210, or other processing units, such as a write-back-invalidate (WBINVD) instruction. Cache flushing may also be used to support powering down the GPU 205, the CPU 210, or other processing units and the device 200 for various power saving states. For example, the CPU core(s) 225 may be powered down (e.g., the voltage supply is set to 0V in a c6 state) and the CPU 210 and the caches/buffers 230, 231, 232 may be powered down several times per second to conserve the power used by these elements when they are powered up.

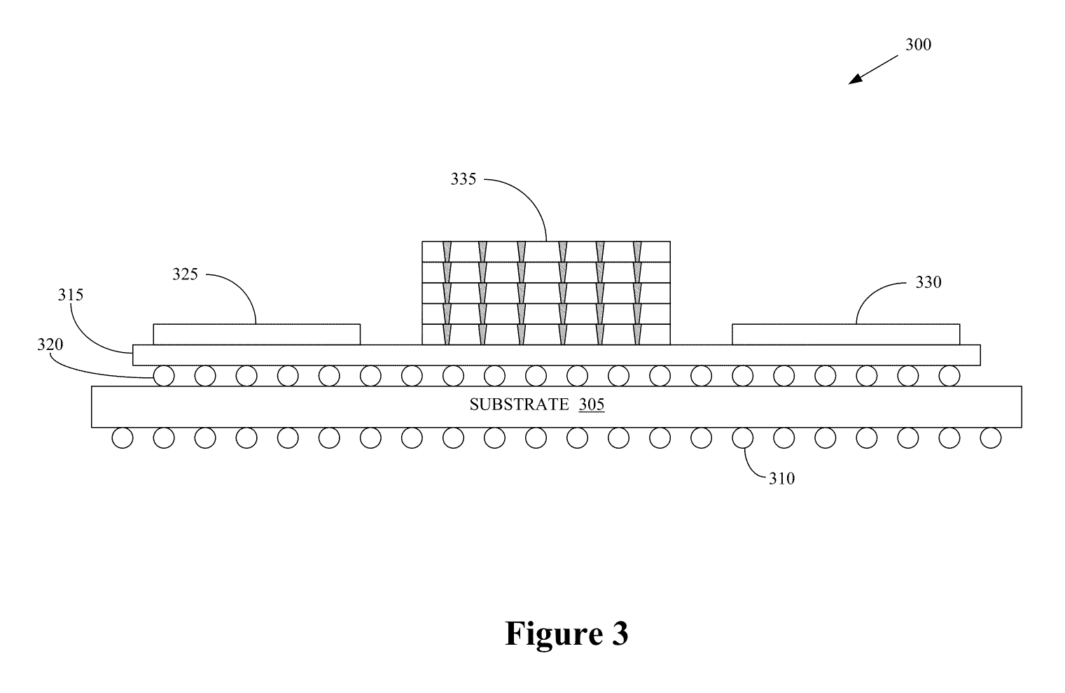

FIG. 3 conceptually illustrates a third exemplary embodiment of a semiconductor device 300. In the illustrated embodiment, the semiconductor device 300 includes a substrate 305 that uses a plurality of interconnections such as solder bumps 310 to facilitate electrical connections with other devices. The semiconductor device 300 also includes an interposer 315 that can be electrically and/or communicatively coupled to circuitry formed in the substrate 305 using interconnections such as solder bumps 320. The interposer 315 is an electrical interface that routes signals between one socket/connection and another. Circuitry in the interposer 315 may be configured to spread a connection to a wider pitch (e.g., relative to circuitry on the substrate 305) and/or to reroute a connection to a different connection.

The third exemplary embodiment of the semiconductor device 300 includes multiple processors such as a graphics processing unit (GPU) 325 and a central processing unit (CPU) 330 that are physically, electrically, and/or communicatively coupled to the interposer 315. Additional processors such as an accelerated processing unit (APU) may be included in other embodiments of the semiconductor device 300. The third exemplary embodiment of the semiconductor device 300 also includes a memory stack 335 that is implemented as a through-silicon-via (TSV) stack of memory elements. The memory stack 335 is physically, electrically, and/or communicatively coupled to the interposer 315, which may therefore facilitate electrical and/or communicative connections between the GPU 325, the CPU 330, the memory stack 335, and the substrate 305. One embodiment of the memory stack 335 has a size of approximately 512 MB, is self-refresh capable, and may be at least 50% faster than generic system memory. However, persons of ordinary skill in the art having benefit of the present disclosure should appreciate that these parameters are exemplary and alternative embodiments of the memory stack 335 may have different sizes, speeds, and/or refresh capabilities.

In the illustrated embodiment, a common cache is implemented using portions of the memory stack 335. The portions of the memory stack 335 that are used for the common cache may be defined, allocated, and/or assigned by other functions in the system 300 such as functionality in the GPU 325 and/or the CPU 330. Allocation may be dynamic or according to predetermined allocations. The common cache provides caching for the GPU 325 and the CPU 330, as discussed herein. In one embodiment, the third exemplary embodiment of the semiconductor device 300 may be implemented or formed as part of the first exemplary embodiment of the computer system 100. For example, the GPU 325 may correspond to the GPU 125, the CPU 330 may correspond to the CPU 140, and portions of the memory elements 160, 195 may be implemented in the memory stack 335. However, alternative embodiments of the semiconductor device 300 may be implemented in systems that differ from the exemplary embodiment of the computer system 100 shown in FIG. 1.

In some embodiments, the memory stack 335 may be used for other functions. For example, portions of the memory stack 335 may be allocated to dedicated local area memory for the GPU 325. Proper operation of the GPU 325 with non-uniform video memory segments may require exposing the memory segments into the operating system and/or user mode drivers as independent memory pools. Since primary video memory pool which requires high performance may be a visible video memory segment, a portion of the stacked memory 335 may be exposed as a visible local video memory segment, e.g., with current typical size of 256 MB. Alternatively, the interposer memory size can be increased. These portions of the memory stack 335 may be allocated to surfaces demanding high bandwidth for read/write operations such as color buffers (including AA render targets), depth buffers, multimedia buffers, and the like. For another example, a dedicated region of the memory stack 335 may be allocated to shadow the CPU cache memories during power-down operations such as C6. Shadowing the cache memories may improve the C6 enter/exit time.

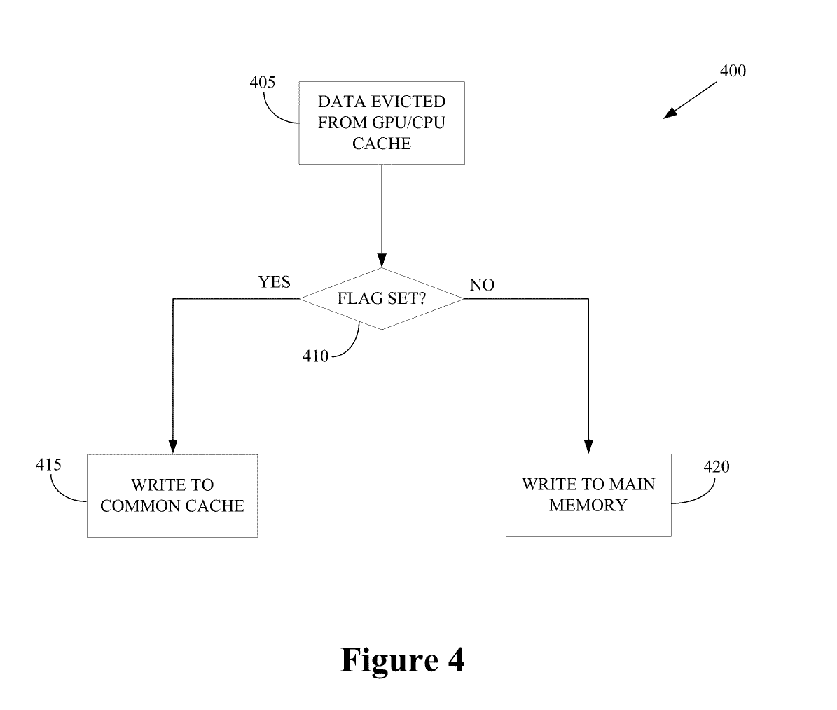

FIG. 4 conceptually illustrates one exemplary embodiment of a method 400 of selectively caching inter-operation data. In the illustrated embodiment, data is evicted (at 405) from a cache associated with a GPU or CPU in a heterogeneous computing environment. The system then determines (at 410) whether a flag has been set that indicates that the data is associated with inter-operations, e.g., the data is expected to be accessed by both the GPU and CPU or other processing units in the system. Although a flag is used to indicate that the data is interoperation data, alternative embodiments may use other techniques to select a particular subset of data for caching in the common cache associated with the GPU and CPU. If the flag has been set, the evicted data may be written (at 415) to the common cache so that it can be subsequently accessed by the GPU and/or the CPU. If the flag has not been set, the evicted data bypasses the common cache and is written (at 420) back to the main memory.

Embodiments of processor systems that can implement selective caching of interoperation data as described herein (such as the processor system 100) can be fabricated in semiconductor fabrication facilities according to various processor designs. In one embodiment, a processor design can be represented as code stored on a computer readable media. Exemplary codes that may be used to define and/or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarizing, metrology, and other processes that are used to form transistors and other circuitry on semiconductor substrates. The processing tools can be configured and are operated using the intermediate representation, e.g., through the use of mask works generated from GDSII data.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
allocating a portion of a first cache for caching data for at least two processing elements; and
defining a replacement policy for the allocated portion of the first cache, wherein the replacement policy restricts access to the first cache to operations associated with more than one of said at least two processing elements.

2. The method of claim 1, comprising caching data in the first cache according to the replacement policy in response to the data being evicted from at least one of said at least two processing elements.

3. The method of claim 2, comprising determining that the evicted data is eligible to be written to the first cache based on a flag associated with the evicted data.

4. The method of claim 3, comprising setting the flag associated with the data to indicate that the data is eligible to be written to the first cache when the data is associated with inter-operations performed by more than one of said at least two processing elements.

5. The method of claim 3, wherein the flag associated with the data is not set when the data is associated with an operation performed by only one of said at least two processing elements, and wherein the evicted data bypasses the first cache when the flag associated with the data is not set.

7. The method of claim 2, wherein caching the data in the first cache comprises caching data that has been evicted from at least one of an L1 cache, an L2 cache, or a write/combine buffer in a central processing unit.

8. The method of claim 2, wherein caching the data in the first cache comprises caching data that has been evicted from a cache in a graphics processing unit.

9. The method of claim 1, wherein the first cache is part of a through-silicon-via memory stack that is communicatively coupled to said at least two processing elements by an interposer.

10. The method of claim 1, wherein said at least two processing elements comprises at least two processor cores.

11. A method, comprising:
caching data in a cache memory that is communicatively coupled to at least two processing elements according to a replacement policy that restricts access to the cache memory to data for operations associated with more than one of said at least two processing units.

12. The method of claim 11, comprising caching data that has been evicted from memory associated with one of said at least two processing elements in response to determining that the evicted data is eligible to be written to the cache memory based on a flag associated with the evicted data.

13. The method of claim 11, wherein caching the data in the cache memory comprises caching data that has been evicted from at least one of an L1 cache, an L2 cache, or a write/combine buffer in a central processing unit.

14. The method of claim 11, wherein caching the data in the cache memory comprises caching data that has been evicted from a cache in a graphics processing unit.

15. The method of claim 11, wherein the cache memory is part of a through-silicon-via memory stack that is communicatively coupled to said at least two processing elements by an interposer.

16. The method of claim 11, wherein said at least two processing units comprise at least two processor cores.

17. An apparatus, comprising:
means for allocating a portion of a first cache for caching data for at least two processing elements; and
means for defining a replacement policy for the allocated portion of the first cache, wherein the replacement policy restricts access to the first cache to operations associated with more than one of said at least two processing elements.

18. An apparatus comprising:
a cache for caching data in a cache memory that is communicatively coupled to at least two processing elements according to a replacement policy that restricts access to the cache memory to data for operations associated with more than one of said at least two processing elements.

19. The apparatus of claim 18, wherein the cache comprises a cache management unit, said cache management unit enforcing said replacement policy.

20. The apparatus of claim 18, wherein said cache management unit allocates a portion of the cache for caching data for the least two processing elements.

21. An apparatus, comprising:
at least two processing elements; and
a first cache that is communicatively coupled to said at least two processing elements, wherein the first cache is adaptable to cache data according to a replacement policy that restricts access to the first cache to operations associated with more than one of said at least two processing elements.

22. The apparatus of claim 21, wherein said at least two processing elements are configured to write data to the first cache in response to determining that the evicted data is eligible to be written to the first cache based on a flag associated with the evicted data.

23. The apparatus of claim 22, wherein each processing element is configured to set the flag associated with the data to indicate that the data is eligible to be written to the first cache when the data is associated with inter-operations performed by more than one of said at least two processing elements.

24. The apparatus of claim 22, wherein the flag associated with the data is not set when the data is associated with an operation performed by only one of said at least two processing elements, and wherein the evicted data bypasses the first cache when the flag associated with the data is not set.

25. The apparatus of claim 21, wherein said at least two processing elements comprise a central processing unit and a graphics processing unit.

26. The apparatus of claim 25, wherein the central processing unit comprises at least one of an L1 cache, an L2 cache, or a write/combine buffer, and wherein the graphics processing unit comprises at least one cache.

27. The apparatus of claim 21, wherein said at least two processing elements comprise at least two processor cores.

28. The apparatus of claim 21, comprising:
a substrate;
an interposer formed on the substrate; and
a through-silicon-via memory stack that is communicatively coupled to said at least two processing elements via the interposer, and wherein the first cache is part of the through-silicon-via memory stack.
